(19) United States
(12) Patent Application Publication
(10) Pub. No.: US 2026/0115833 A1
(43) Pub. Date: Apr. 30, 2026

(54) LASER WELDING-BRAZING METHOD FOR ALUMINUM AND STEEL DISSIMILAR METALS

(71) Applicant: Nanchang Hangkong University, Nanchang City (CN)

(72) Inventors: Yida ZENG, Nanchang City (CN); Shuguo ZHANG, Nanchang City (CN); Peiyang FANG, Nanchang City (CN); Zhenghua GUO, Nanchang City (CN); Gangyao ZHAO, Nanchang City (CN); Zemin LIU, Nanchang City (CN); Ruizhi LI, Nanchang City (CN)

(73) Assignee: Nanchang Hangkong University, Nanchang City (CN)

(21) Appl. No.: 19/383,509

(22) Filed: Nov. 7, 2025

(30) Foreign Application Priority Data
Nov. 11, 2024 (CN) 202411595583.7

(51) Int. Cl. B23K 26/323

(52) U.S. Cl. CPC B23K 26/323

(57) ABSTRACT

The present disclosure provides a laser welding-brazing method for aluminum and steel dissimilar metals, and belongs to the field of precision connection technology for dissimilar metals. The laser welding-brazing method adopted in the present disclosure is between fusion welding and brazing, combining high-strength structure of fusion welding and good wettability of brazing, and can obtain high-strength welded joints. The present disclosure first processes Al—Fe connection interface to be welded to have slope-shaped grooves before welding. Compared with vertical-surface jointing and welding, the method of the present disclosure improves mechanical properties of joint and effectively suppresses pore defects. Synergistic effect of slope-shaped half-lap-type groove and laser welding-brazing using laser organically unifies welding structure and metallurgical regulation, improves geometric and mechanical structure, interface metallurgical reaction, microstructure segregation, and welding defects of aluminum/steel plate jointing welding, and obtains laser welding-brazing joints with excellent microstructure and mechanical properties.

### CROSS-REFERENCE TO RELATED APPLICATION

This application claims priority to Chinese Patent Application No. 202411595583.7, filed on Nov. 11, 2024, which is hereby incorporated by reference in its entirety.

### TECHNICAL FIELD

The present disclosure belongs to the field of precision connection technology for dissimilar metals, and specifically relates to a laser welding-brazing method for aluminum and steel dissimilar metals.

### BACKGROUND ART

Aluminum and steel, as two typical metal engineering materials, play indispensable roles in manufacturing of electronic devices and structural members due to their unique physical and chemical properties. However, designing for energy conservation, emission reduction, weight reduction, cost reduction and efficiency improvement has become an important development trend in the engineering field. Application of a single material often fails to meet comprehensive performance requirements under complex working conditions. Therefore, welding technology of aluminum and steel dissimilar materials has emerged, which combines characteristics of lightweight and high strength, high electrical/thermal conductivity, and corrosion resistance of aluminum and steel with high load-bearing capacity and low cost of steel. The welding technology of aluminum not only optimizes configuration of material properties, but also significantly reduces weight of overall structure, improving energy efficiency and environmental performance. Therefore, the welding technology has a wide range of applications in engineering fields such as electrical device and heat dissipation assemblies thereof, automotive lightweighting, structural members in aviation and aerospace, rail transportation, and petroleum pipelines.

However, there are still many problems with aluminum/steel welding at present. Due to significant differences in properties such as melting point, thermal/electrical conductivity, and expansion coefficient of aluminum/steel, there is a higher tendency for residual stress and cracking during the welding process. However, the solid solubility between aluminum and iron is extremely low, and chemical reactions are prone to occur at high temperatures, leading to formation of brittle intermetallic compounds (IMCs) such as FeAl₃, Fe₂Al₅, Fe₂Al, etc., with almost zero solid solubility of aluminum and iron atoms in liquid metal state. Aluminum generates Al₂O₃ at high temperatures, and when thickness of intermetallic compounds (IMCs) layer is greater than 10 μm, excessive brittle intermetallic compounds in the weld seam will seriously reduce mechanical properties represented by toughness.

To improve welding quality of aluminum/steel, researchers have made technological improvements to typical welding methods: traditional fusion-welding method, combined with Taguchi method, response surface methodology, and other experimental design methods, optimizes parameters such as average power, peak power, pulse width, frequency, welding speed, etc., finds a combination of optimal parameters to reduce generation of intermetallic compounds and cracks, and improves welding quality. However, it is difficult to completely avoid the formation of intermetallic compounds which increase brittleness of joint by optimizing process parameters only. And fusion welding usually requires high energy input and long welding time, which can easily result in high heat input, causing welding defects and excessive residual stress. Brazing is particularly suitable for welding between dissimilar metals, and the melting point of the brazing material is lower than that of the connected metal. Therefore, the connected metal will not be melted during the connection process, resulting in very low thermal stress and deformation. Surface of the joint is smooth and flat, suitable for welding high-precision components such as electronic component packaging, heat sink of electronic device, and metal crafts. However, the welding time of brazing is relatively long, and the weld seam basically does not generate a layer of intermetallic compound, resulting in no metallurgical bonding between the welded metals and relatively low strength of weld seam. Therefore, brazing is not suitable for welding components under high load conditions and high temperature environments. Thus, it is an urgent need for a welding method that can achieve better mechanical properties.

### SUMMARY

The purpose of the present disclosure is to provide a laser welding-brazing method for aluminum and steel dissimilar metals. The method adopted in the present disclosure can obtain welded joints with no obvious defects and excellent mechanical properties.

In order to achieve the above objectives, the present disclosure provides following technical solutions:

The present disclosure provides a laser welding-brazing method for aluminum and steel dissimilar metals, including following steps:
step (1): processing a jointed side of each of an aluminum plate and a steel plate to have a slope-shaped groove to obtain an aluminum plate having slope-shaped groove and a steel plate having slope-shaped groove; where an angle between a bevel of a groove and the bottom edge of the steel plate is less than 90 degrees; and where a sum of the angle and an angle between a bevel of a groove and the bottom edge of the aluminum plate is 180 degrees;
step (2): coating a mixed slurry on the groove of the steel plate having slope-shaped groove obtained in step (1) to obtain a steel plate containing coating layer; where the mixed slurry is made by mixing Nocolok® flux powder with acetone; and
step (3): jointing the aluminum plate having slope-shaped groove obtained in step (1) and the steel plate containing coating layer obtained in step (2) and welding a jointed seam by using laser to obtain a composite plate.

In some embodiments, in step (1), the angle between the bevel of the groove and the bottom edge of the steel plate having slope-shaped groove is 20˜70 degrees.

In some embodiments, in step (2), a thickness of the coating layer is 20˜40 μm.

In some embodiments, in step (2), the thickness of the coating layer is 30 μm.

In some embodiments, in step (2), a mass ratio of the Nocolok® flux powder and the acetone in the mixed slurry is 1: (2˜3).

In some embodiments, in step (2), a preprocessing process is performed before coating surface of the steel plate having slope-shaped groove.

In some embodiments, when the jointing is performed, the aluminum plate having slope-shaped groove is arranged above the steel plate containing coating at a jointing position.

In some embodiments, when the welding is performed by laser welding, The laser beam is deflected toward the aluminum plate, which features a slope-shaped groove.

In some embodiments, an offset distance between a center of a spot of the laser beam and the jointed seam is calculated according to Formula I:

$$d = 0.6 ∼ 0.8 * ( b / tan θ ) ;$$

where in Formula I, d represents the offset distance, b represents a thickness of a steel and aluminum plate to be welded, and θ represents the angle between the bevel of the groove and the bottom edge of the steel plate having slope-shaped groove.

In some embodiments, in step (3), a power of the laser beam is 1˜4 kW, a welding speed is 0.4˜1.2 m/min, a defocusing amount is +1˜30 mm, and an inclination angle of the laser beam is 5˜20 degrees.

The present disclosure provides a laser welding-brazing method for aluminum and steel dissimilar metals using laser, including following steps: step (1): processing a jointed side of each of an aluminum plate and a steel plate to have a slope-shaped groove to obtain an aluminum plate having slope-shaped groove and a steel plate having slope-shaped groove; where an angle between a bevel of a groove and a bottom edge of the steel plate having slope-shaped groove is less than 90 degrees; and where a sum of the angle and an angle between a bevel of a groove and a bottom edge of the aluminum plate having slope-shaped groove is 180 degrees; step (2): coating a mixed slurry on the groove of the steel plate having slope-shaped groove obtained in step (1) to obtain a steel plate containing coating layer; where the mixed slurry includes Nocolok® powder and acetone; and step (3): jointing the aluminum plate having slope-shaped groove obtained in step (1) and the steel plate containing coating layer obtained in step (2) and welding a jointed seam by using laser to obtain a composite plate. The laser welding-brazing method adopted in the present disclosure is between fusion welding and brazing, combining high-strength structure of the fusion welding and good wetting properties of the brazing, and can obtain high-strength welded joints. Firstly, a welding process is performed after processing a jointed side of each of an aluminum plate to be welded and a steel plate to be welded to have a slope-shaped groove. Compared to butt joining of vertical surfaces, bonding area of the welding interface increases, and stress area of the weld seam increases without changing the thickness of the base material, improving the mechanical properties of the joint. The aluminum side does not need to be complete melting, and the average melting depth of the base material in the melted zone decreases. Under the same heat input, energy of brazing interface used for aluminum/steel solid-liquid diffusion reaction increases, increasing the thickness of layer of the intermetallic compound of the structural structure, and improving the uniformity of the thickness of layer of the intermetallic compound near the joint interface, improving the stress concentration caused by segregation of cross-sectional structure when subjected to external forces. In addition, the liquid metal is less prone to collapse during welding, which enhances stability of the keyhole. And existence of the slope-shaped groove limits the maximum depth of the keyhole, shortening the distance required for bubbles in the molten pool to escape from the liquid metal. The Marangoni convection generated by the difference in surface tension in the liquid metal stirs the molten pool, causing the laser beam to flow up and down along the slope on both sides of the molten pool, providing greater driving force for the movement of bubbles in the molten pool and effectively suppressing defects such as pores. The synergistic effect of the slope-shaped half-lap-type groove and laser welding-brazing organically unifies the weld structure and metallurgical regulation, improves the geometric and mechanical structure, interface metallurgical reaction, microstructure segregation, and welding defects of Al/steel butt welding joints, and obtains laser welding-brazing joints with excellent microstructure and mechanical properties. The results of the embodiments show that the average tensile strength of the joint obtained by the method of the present disclosure is 125.42 MPa, while the average tensile strength of the joint obtained by vertical jointing and welding is 81.61 MPa.

### BRIEF DESCRIPTION OF THE DRAWINGS

FIG. 1 is a schematic diagram of the welding structure of the laser welding-brazing method for aluminum and steel dissimilar metals using laser provided by the present disclosure.

FIG. 2 shows a macroscopic morphology of a welded joint of aluminum and steel dissimilar metals in Embodiment 1 of the present disclosure.

FIG. 3 shows a macroscopic morphology of a welded joint of aluminum and steel dissimilar metals in Embodiment 2 of the present disclosure.

FIG. 4 shows a macroscopic morphology of a welded joint of aluminum and steel dissimilar metals in Comparative Embodiment 1.

FIG. 5 shows an SEM diagram of an interface of the welded joint of aluminum and steel dissimilar metals in Embodiment 1 of the present disclosure.

FIG. 6 shows an SEM diagram of an interface of the welded joint of aluminum and steel dissimilar metals in Comparative Embodiment 1.

FIG. 7 shows a comparison diagram of mechanical properties of the welded joint of aluminum and steel dissimilar metals among Embodiment 1 and Embodiment 2 of the present disclosure as well as Comparative Embodiment 1.

### DETAILED DESCRIPTION OF THE EMBODIMENTS

The present disclosure provides a laser welding-brazing method for aluminum and steel dissimilar metals, including following steps (1) to (3).

In step (1), a jointed side of each of an aluminum plate and a steel plate is processed to have a slope-shaped groove to obtain an aluminum plate having slope-shaped groove and a steel plate having slope-shaped groove.

In step (2), a mixed slurry is coated on the groove of the steel plate having slope-shaped groove obtained in step (1) to obtain a steel plate containing coating layer.

In step (3), the aluminum plate having slope-shaped groove obtained in step (1) and the steel plate containing coating layer obtained in step (2) are jointed and a weld seam is welded by using laser to obtain a composite plate.

In the present disclosure, a jointed side of each of an aluminum plate to be welded and a steel plate to be welded is processed to have a slope-shaped groove to obtain an aluminum plate having slope-shaped groove and a steel plate having slope-shaped groove.

In the present disclosure, an angle between a bevel of a groove and a bottom edge of the steel plate having slope-shaped groove is less than 90 degrees; preferably the angle is 20˜70 degrees; more preferably the angle is 30˜60 degrees; and further preferably the angle is 40˜45 degrees.

In the present disclosure, a sum of an angle between a bevel of a groove and a bottom edge of the aluminum plate having slope-shaped groove and the angle between the bevel of the groove and the bottom edge of the steel plate having slope-shaped groove is 180 degrees. That is, the angle between the bevel of the groove and the bottom edge of the aluminum plate having slope-shaped groove and the angle between the bevel of the groove and the bottom edge of the steel plate having slope-shaped groove are supplementary angles, which is beneficial for subsequent joint of the aluminum plate and the steel plate.

The present disclosure does not have any special limitations on the method of processing a jointed side of each of the aluminum plate to be welded and the steel plate to be welded to have a slope-shaped groove, and the processing methods well known to those skilled in the art can be used to ensure that the angle between the bevel of the groove and the bottom edge of the plates meet the above requirements.

The present disclosure does not have any special limitations on specific types and models of the steel plate and the aluminum plate, and any steel plate and the aluminum plate well known to those skilled in the art can be used.

In the present disclosure, the method of processing a jointed side of each of the aluminum plate to be welded and the steel plate to be welded to have a slope-shaped groove preferably includes wire cut electrical discharge machining. The present disclosure preferably uses an adjustable angle fixture to process the plates. The present disclosure does not have any specific limitations on specific structures of the adjustable angle fixture, and any adjustable angle fixture well known to those skilled in the art can be used.

In the present disclosure, after obtaining the steel plate having slope-shaped groove, a mixed slurry is coated on surface of the groove of the steel plate having slope-shaped groove to obtain a steel plate containing coating layer.

In the present disclosure, a preprocessing process is preferably performed before coating surface of the steel plate having slope-shaped groove.

In the present disclosure, the preprocessing process preferably and successively includes: mechanical polishing of the groove and vicinity of the groove, acetone soaking of the steel plate having slope-shaped groove, and alcohol wiping and drying of the groove.

The present disclosure does not have special limitations on specific operations on mechanical polishing of the groove and vicinity of the groove, any operations can be used to ensure that the processing traces of processing the groove can be eliminated. The present disclosure can improve the flatness of the surface of the plate to be welded, making the base materials tightly bonded and avoiding defects such as pores.

The present disclosure does not have special limitations on specific operations of acetone soaking and alcohol wiping, any operations can be used to remove oil stains and oxides on the surface of the plates to be welded.

The present disclosure does not have special limitations on operations of drying, any operations can be used to ensure that the groove is fully dried.

In the present disclosure, the mixed slurry includes Nocolok® powder and acetone.

In the present disclosure, grain size of the Nocolok® powder is preferably 0.1˜1 μm.

In the present disclosure, a mass ratio of the Nocolok® powder and the acetone is preferably 1:(2˜3).

In the present disclosure, a thickness of the coating layer is preferably 20˜40 μm; more preferably 25˜35 μm; and further preferably 30 μm. In the present disclosure, the mixed slurry is coated on the jointing position at the groove of the steel plate to be welded, with the aim of improving the wettability of molten aluminum on the surface of solid steel and removing the oxide film on the surface of aluminum alloy. During the welding process, the aluminum alloy is directly heated and melted into a liquid state, while the steel is indirectly heated and does not be fused and remains a solid state. Therefore, coating on the steel side is beneficial for reducing the loss of brazing material caused by melting of aluminum alloy and stirring of the molten pool when coating the brazing material on the aluminum alloy side, and also for improving the wettability of fusion aluminum on the surface of solid steel. The present disclosure limits the thickness of the coating layer within the above range, which can further improve the mechanical properties of the joint.

The present disclosure preferably uses a feeler of corresponding thickness as a reference during coating, gradually retracting the feeler along the welding direction for multiple coatings, and scraping off excess slurry with a cover slip to ensure uniform thickness of coating layer.

After obtaining the aluminum plate having slope-shaped groove and the steel plate containing coating layer, the aluminum plate having slope-shaped groove and the steel plate containing coating layer are jointed and a jointed seam is welded by laser to obtain a composite plate.

In the present disclosure, a preprocessing process is preferably performed before jointing the aluminum plate having slope-shaped groove.

In the present disclosure, the preprocessing manner of the aluminum plate having slope-shaped groove is preferably same as that of the steel plate having slope-shaped groove. No further elaboration will be provided here.

In the present disclosure, the aluminum plate having slope-shaped groove and the steel plate containing coating layer after the preprocessing process are preferably clamped onto the welding fixtures, and then a laser welding process is performed.

The present disclosure does not have any special limitations on the structures of the welding fixtures, any structures commonly used by those skilled in the art can be used.

The fixtures in the present disclosure are jointed through half-lap-type grooves of the aluminum and steel base materials, making the angle between the bevel of the groove and the bottom edge of the aluminum plate having slope-shaped groove and the angle between the bevel of the groove and the bottom edge of the steel plate having slope-shaped groove are supplementary angles, forming a jointed joint having half-lap-type grooves. The groove of the aluminum side base material is located above, and the groove of the steel side base material is located below. The focus of the laser beam is located above the joint, irradiating the base materials below the focus of the laser beam.

In the present disclosure, when the jointing is performed, the aluminum plate having slope-shaped groove is preferably arranged above the steel plate containing coating laser at a jointing position.

In the present disclosure, when the welding is performed by using laser, a laser beam is preferably aimed at one side of the aluminum plate. In the present disclosure, the aluminum plate is controlled to be arranged above the steel plate, and when the welding is performed by using laser, the laser beam is aimed at one side of the aluminum plate, with the aim of fusing the low-melting-point aluminum base material and avoiding the steel base material from melting heavily due to heat. In addition, by regulating the irradiation position of the laser beam, the heat transfer at each position of the aluminum/steel interface can be balanced, making the reaction process at each position consistent.

In the present disclosure, when the welding is performed by using laser, an offset distance between a center of a spot of the laser beam and the jointed seam is calculated according to Formula I:

d=0.6˜0.8*(b/tan θ);

in Formula I, d represents the offset distance, b represents a thickness of a steel plate to be welded, and θ represents the angle between the bevel of the groove and the bottom edge of the steel plate having slope-shaped groove.

In the present disclosure, when the welding is performed by using laser, a certain distance between the center of the spot of the laser beam and the joint seam is offset, in order to ensure that the heat inputs acting on the aluminum alloy base material located at left and right sides of the laser beam are the same, and ensure uniform heat transfer of the slope-shaped groove of the steel side during the welding process. The present disclosure limits the offset distance within the above range, which can further improve the mechanical properties of the joint.

In the present disclosure, the power of the laser beam is preferably 1˜4 kW, more preferably 2˜3 kW. The welding speed is preferably 0.4˜1.2 m/min, more preferably 0.5˜0.8 m/min. The defocusing amount is preferably +1˜30 mm, more preferably +2˜20 mm. The inclination angle of the laser beam is preferably 5˜20 degrees, more preferably 5˜10 degrees. The present disclosure limits parameters of laser welding within the above ranges, which can increase heating area of the plate to be welded and further improve the mechanical properties of the joint.

The laser welding-brazing method used in the present disclosure is between the fusion welding and the brazing, combining the high-strength joint of the fusion welding with the good wettability of the brazing, and can obtain high-strength welded joints. Compared to traditional brazing, only a portion of the base material is melted during welding, which can improve the mechanical properties of the joint. And the laser used as a heat source can achieve rapid heating and cooling, improving production efficiency. Compared to traditional fusion welding, the method of the present disclosure can prevent direct contact and mutual reaction between aluminum and steel liquid metals, effectively suppress generation of a large amount of intermetallic compounds, prevent excessive thickness of intermetallic compounds layer from causing brittle joints and micro cracks, and reduce the structural strength of the joint. The above beneficial effects are mainly due to the fact that in order to achieve effective connection between aluminum and steel dissimilar metals, a certain amount of Al—Fe intermetallic compounds must be generated, and when the thickness of the layer of intermetallic compound is less than 10 μm, the amount generated is proportional to the strength of the joint. When the thickness of the layer of intermetallic compound is greater than 10 μm, the strength of the joint usually decreases.

Compared with direct jointing of vertical surfaces, the slope-shaped half-lap-type groove processed by the present disclosure has an increased bonding area of welding-brazing interface. Therefore, without changing the thickness of the base material, the stress area of the weld seam increases, directly improving the mechanical properties of the joint. The machining method for the slope-shaped groove is simple, flexible, and low-cost, and the slope-shaped groove can be prepared using low-cost machining processes such as wire cutting machines, chamfering machines, and beveling machines. Due to the lack of large-area melting of the aluminum side, the average melting depth of the base material in the melted zone is reduced. Therefore, under the same heat input, an increase in energy at the brazing interface used for aluminum/iron solid-liquid diffusion reaction can increase the thickness of the layer of intermetallic compound in the joint. Due to the use of the slope-shaped half-lap-type groove and adjustment of laser offset, uniform heat transfer can be achieved at different positions of the laser welding-brazing interface, thereby greatly improving the uniformity of the thickness of layer of the intermetallic compound near the interface of the joint and improving stress concentration caused by interface structure segregation under external forces. Due to the uniform heat transfer at the interface, it is also convenient to precisely regulate the thickness of layer of the intermetallic compound by adjusting parameters of the laser, so as to maintain the joint within the optimal range of structure and properties.

In the technical solution of the present disclosure, the laser beam divides aluminum fusion welding zone into two zones: a triangular zone near the steel side has less aluminum alloy base material, slow heat dissipation speed, and low energy required for melting; and a zone near the aluminum side has much aluminum alloy base material, fast heat dissipation speed, and high energy required for melting this zone. Therefore, the offset distance of the laser is limited to the above ranges of aluminum side, which can balance the heat radiation absorbed by the base materials arranged on both sides of the laser during the welding process and achieve uniform radiation heat transfer in terms of heat transfer. On the basis of the slope-shaped half-lap-type groove processed by the present disclosure, the keyhole is located above the slope-shaped groove during the advancement process of the laser beam. The slope-shaped groove on the steel side can provide support for the keyhole. Compared to the jointed joint with vertical cross section, the liquid metal is less likely to collapse, improving the stability of the keyhole. In addition, due to the existence of the slope-shaped groove, the maximum depth of the keyhole is limited, and the distance required for bubbles in the molten pool to escape from the liquid metal is shortened. And the Marangoni convection generated by the differences in surface tension of the liquid metal stirs the molten pool, causing the molten pool on both sides of the laser beam to flow up and down along the slope, providing greater driving force for the movement of bubbles in the molten pool. Therefore, welding defects such as pores are effectively suppressed. The synergistic effect of the slope-shaped half-lap-type groove and laser welding-brazing organically unifies the welding structure and metallurgical regulation, improves the geometric and mechanical structure, interface metallurgical reaction, microstructure segregation, and welding defects of jointing welding for aluminum/steel plate, and obtains laser welding-brazing joints with excellent microstructure and mechanical properties.

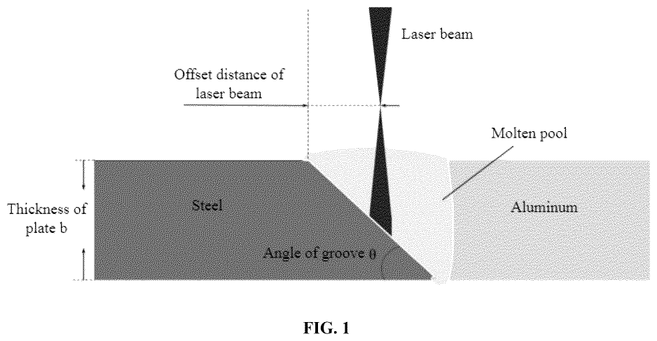

The schematic diagram of the welding structure of the laser welding-brazing method for aluminum and steel dissimilar metals using laser provided by the present disclosure is shown in FIG. 1. The angle of the groove in FIG. 1 refers to the angle between the bevel of the steel plate having slope-shaped groove and the bottom edge of the steel plate having slope-shaped groove.

The technical solution of the present disclosure will be clearly and completely described below in conjunction with the embodiments of the present disclosure. Obviously, the described embodiments are only a part of the embodiments of the present disclosure, not all embodiments. Based on the embodiments of the present disclosure, all other embodiments obtained by ordinary skilled in the art without creative labor are within the scope of protection of the present disclosure.

### Embodiment 1

A laser welding-brazing method for aluminum and steel dissimilar metals using laser is provided, which includes following special steps (1) to (3).

In step (1), an cutting machine having a wire electrical discharge and a fixture having a tilting-type guide rod are used. The fixture can be tilted within a range of 0˜90 degrees. After adjusting to the desired angle, the fixture is fixed with an angle locking pin and a quick locking device. Then, the joint sides of the aluminum plate to be welded and the steel plate to be welded are processed to have slope-shaped grooves to obtain the aluminum plate having slope-shaped groove and the steel plate having slope-shaped groove. The angle between the bevel of groove of the steel plate and the bottom edge of the steel plate (i.e., the angle of the groove) is 45 degrees, and the angle between the bevel of the groove of the aluminum plate and the bottom edge of the aluminum plate is 135 degrees. The used aluminum plate is 6061-T6 aluminum alloy plate, and the used steel plate is 316 stainless steel plate with a thickness of 1.5 mm.

In step (2), the grooves of the processed aluminum plate having slope-shaped groove and the processed steel plate having slope-shaped groove and 20 mm areas on both sides of the grooves are mechanically polished until the processing traces of wire cutting are completely eliminated. Then the mechanically polished aluminum plate and steel plate are soaked in acetone for 20 minutes, then the surfaces to be welded are wiped with alcohol, and the surfaces to be welded are dried with a hair dryer to remove oil stains and oxides on the surface of the aluminum/steel plate to be welded. A mixed slurry made of Nocolok® powder (particle size is 0.1˜1 μm) and acetone in a mass ratio of 1:2 is coated on the jointing position at the groove of the cleaned steel plate to be welded. A 0.03 mm (30 μm) feeler is used to cover and compare, and a 15 mm length of slurry is coated. After drying, a cover slip is used to scrape off the excess slurry, then the feeler is retracted by about 15 mm towards the uncoated direction and the coating steps are repeated until the entire weld seam is evenly coated and the thickness of coating layer is ensured to be 30 μm to obtain the steel plate containing coating layer.

In step (3), the preprocessed aluminum plate having slope-shaped groove and the preprocessed steel plate containing coating layer (the angle between the bevel of the groove and the bottom edge of the aluminum plate and the angle between the bevel of the groove and the bottom edge of the steel plate are supplementary angles) are clamped together to form a half-lap-type welded structure with a form that the aluminum plate is located above and the steel plate is located below. The half-lap-type welded member is clamped onto a universal jointing and welding fixture, and a straight wire welding route is used to perform laser welding. The power of the laser is 2 kW; the welding speed is 0.5 m/min; the defocusing amount is +2 mm; the offset distance between the center of the spot of the laser beam and the jointed seam when the welding is performed using laser is 0.9 mm; and the inclination angle of the laser beam is 5 degrees.

Where the offset distance between the center of the spot of the laser beam and the jointed seam can be calculated according to Formula I:

$$d = 0.6 ∼ 0.8 * ( b / tan θ ) ;$$

in Formula I, d represents the offset distance, b represents a thickness of the steel plate to be welded, and θ represents the angle between the bevel of the groove and the bottom edge of the steel plate having slope-shaped groove.

### Embodiment 2

The only difference from Embodiment 1 and Embodiment 2 is that, in step (3), the welding speed when welding is performed using laser is 0.6 m/min, and all other parameters of Embodiment 2 are the same as that of Embodiment 1.

### Comparative Embodiment 1

The difference from Comparative Embodiment 1 and Embodiment 1 is that the jointed sides of the aluminum plate to be welded and the steel plate to be welded are not processed to have slope-shaped half-lap-type groove, and a plate section-jointing manner is adopted, that is, a vertical-jointing manner is adopted, and other parameters of Comparative Embodiment 1 are the same as that of Embodiment 1.

The weld seam after welding in Embodiment 1 is characterized, and the special method is that: cross-sectional samples are cut from the welded aluminum/steel dissimilar metal joint by using the wire electric discharge cutting machine. The sampling position should ensure coverage of the entire width of the weld seam and a portion of the base material. From the viewing direction, the steel is on the left side and the aluminum alloy is on the right side. Metallographic preparation is performed on the cross-sectional sample and the microstructure of the section of the weld seam is observed by using the optical microscope (OM) and the scanning electron microscope (SEM). Tensile specimens suitable for welding structures are prepared according to the GB/T 228.1-2010 standard, and tensile tests are conducted according to the standard. The maximum load and fracture position are recorded, and the tensile strength and elongation of the joint are evaluated.

The weld seams in Embodiment 2 and Comparative Embodiment 1 are characterized by using the same method. In order to better distinguish the micrographs of Embodiment 1 and Embodiment 2, the sampling direction of the metallographic section of Embodiment 2 is opposite to that of Embodiment 1. That is, in the micrograph of Embodiment 2, the aluminum alloy is on the left side and the steel is on the right side. In order to better distinguish the micrographs of Embodiment 1 and Comparative Embodiment 1, the sampling direction of the metallographic section of Comparative Embodiment 1 is opposite to that of Embodiment 1. That is, in the micrograph of Comparative Embodiment 1, the aluminum alloy is on the left side and the steel is on the right side.

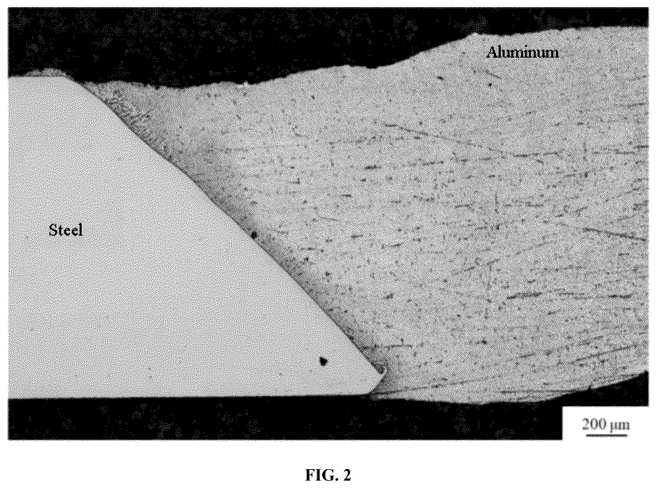

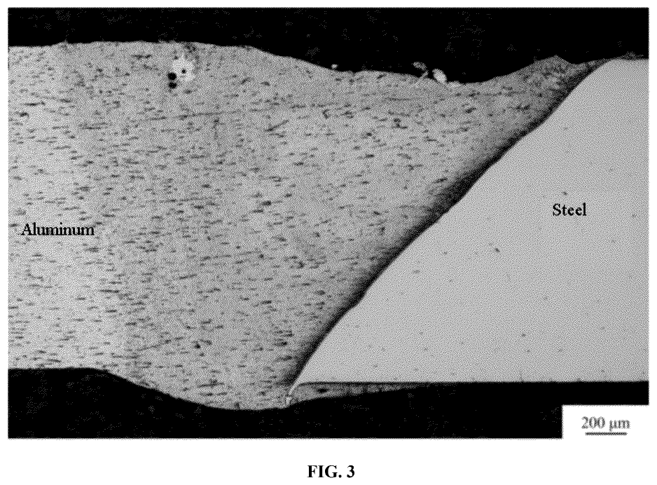

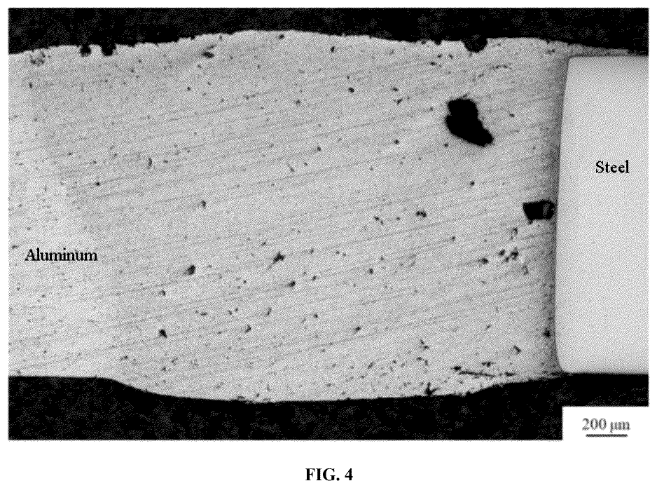

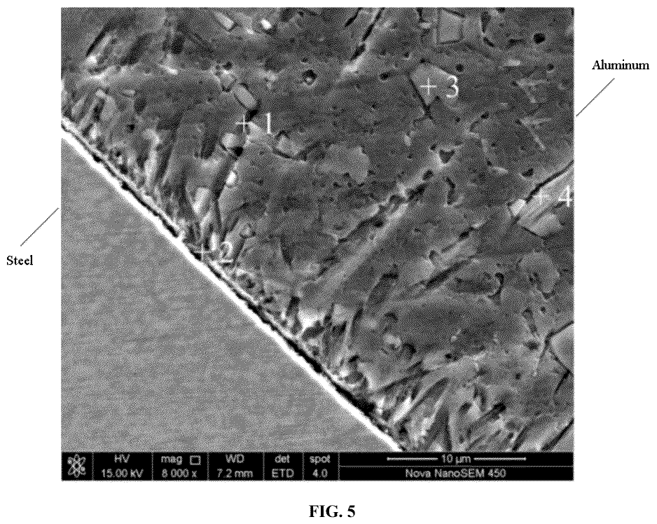

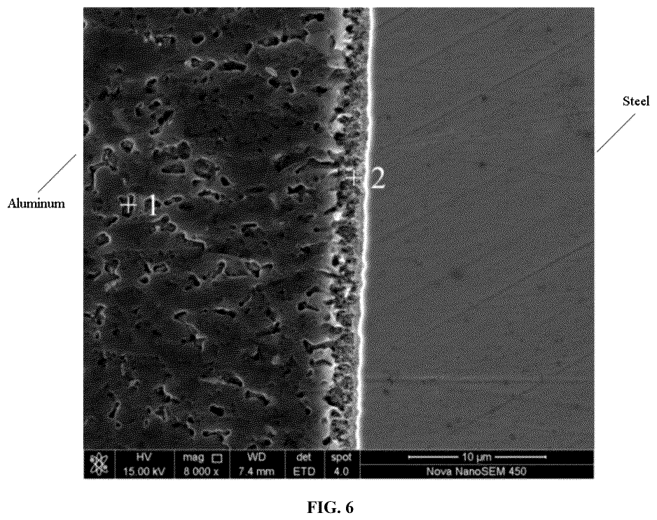

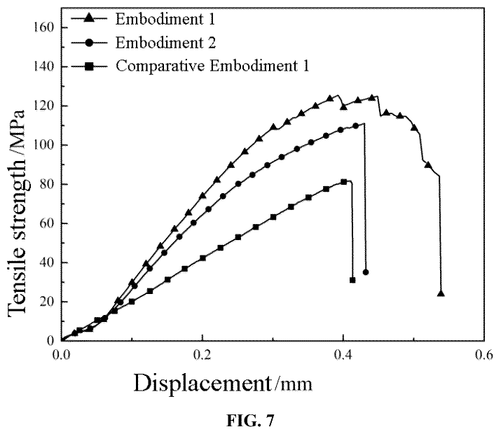

The results are shown in FIGS. 2-7, respectively. FIG. 2 shows a macroscopic morphology of a welded joint of aluminum and steel dissimilar metals in Embodiment 1. FIG. 3 shows a macroscopic morphology of a welded joint of aluminum and steel dissimilar metals in Embodiment 2. FIG. 4 shows a macroscopic morphology of a welded joint of aluminum and steel dissimilar metals in Comparative Embodiment 1. FIG. 5 shows an SEM diagram of an interface of the welded joint of aluminum and steel dissimilar metals in Embodiment 1. FIG. 6 shows an SEM diagram of an interface of the welded joint of aluminum and steel dissimilar metals in Comparative Embodiment 1. FIG. 7 shows a comparison diagram of mechanical properties of the welded joint of aluminum and steel dissimilar metals among Embodiment 1 and Embodiment 2 and Comparative Embodiment 1. The elemental compositions and possible phases generated at different positions of the joints in FIGS. 5-6 are shown in Tables 1 and 2, respectively.

TABLE 1
The elemental compositions and possible phases generated
at different positions of the joint in FIG. 5.

| | Al | Fe | Ni | Cr | Possibly |
|---|---|---|---|---|---|
| Positions | (at. %) | (at. %) | (at. %) | (at. %) | generated phases |
| 1 | 94.36 | 4.40 | — | 1.24 | α-Al |
| 2 | 71.44 | 22.60 | 2.04 | 3.93 | Fe₂Al₅ |
| 3 | 85.88 | 8.97 | — | 5.15 | α-Al + Al—Fe |
| | | | | | eutectoid |
| 4 | 80.73 | 15.34 | 1.24 | 2.69 | Fe₂Al₅ + FeAl₃ |

TABLE 2
The elemental compositions and possible phases generated
at different positions of the joint in FIG. 6.

| | Al | Fe | Ni | Cr | Possibly |
|---|---|---|---|---|---|
| Positions | (at. %) | (at. %) | (at. %) | (at. %) | generated phases |
| 1 | 83.28 | 0.70 | — | 16.02 | α-Al + Al—Cr |
| | | | | | eutectoid |
| 2 | 72.92 | 22.54 | 2.06 | 2.48 | Fe₂Al₅ |

It can be seen from FIGS. 2-4 that both Embodiment 1 and Embodiment 2 can obtain welded joints without obvious defects after processing the auxiliary structure with slope-shaped half-lap-type groove. Only Embodiment 2 has a small number of small-sized circular pores on the upper part of the weld seam on the aluminum side, while Comparative Embodiment 1 has a certain number of pore defects on the joint on the aluminum side. The overall number of pore defects at the joint in Embodiment 1 and Embodiment 2 is significantly reduced, and the generation of irregular process related large pores caused by the instantaneous instability and collapse of the laser keyhole during the welding process is completely suppressed. And due to the shallowness of the molten pool and keyhole compared to Comparative Embodiment 1, the number of small-sized circular pores formed by incomplete gas escape in the molten pool is significantly reduced. The small-sized circular pores appearing in the joint of Embodiment 2 are generated due to the increase in welding speed, which shortens the solidification time of the molten pool. The remaining small amount of gas in the molten pool cannot completely escape and remains at the top part of the molten pool to form pores. This indicates that the processed slope-shaped half-lap-type groove can improve the stability of the keyhole during welding process and suppress the generation of welding defects such as pores. It can be seen from FIGS. 5-6 that the layer of intermetallic compound with the average thickness of 7.93 μm is formed near the aluminum/steel bonding surface in Embodiment 1, while the average thickness of layer of the intermetallic compound in Comparative Embodiment 1 is 1.82 μm. This indicates that the metallurgical bonding effect of the weld seam's metal in Embodiment 1 is better than that in Comparative Embodiment 1, and the average thickness of layer of intermetallic compound in Embodiment 1 does not exceed 10 μm, which is within the optimal microstructure range. According to FIG. 7, the average tensile strength of the joint in Embodiment 1 is 125.42 MPa, the average tensile strength of the joint in Embodiment 2 is 104.53 MPa, and the average tensile strength of the joint in Comparative Embodiment 1 is 81.61 MPa. Compared to Embodiment 2, Embodiment 1 shows a 19.98% increase in tensile strength. Compared to Comparative Embodiment 1, Embodiment 1 shows a 53.6% increase in tensile strength. The fracture form of Embodiment 1 is mixed fracture, while Comparative Embodiment 1 is brittle fracture, indicating that the toughness of the joint in Embodiment 1 has been improved.

In summary, compared with existing technologies, the present disclosure transforms the jointed joint form of aluminum and steel plates into a semi-overlapping form, which can obtain high-performance jointed joints without adding welding wire during welding. Moreover, the slope-shaped groove can be prepared using simple machining equipment, effectively reducing the cost of welding materials and machining. By using the slope-shaped half-lap-type groove, the contact area of the welding-brazing interface can be increased, effectively improving the mechanical properties of the joint. And by adjusting and optimizing the offset distance of the laser, it plays a role in balancing the temperature field of the molten pool during the welding process, making the metallurgical reaction at the interface uniform and reducing the segregation of the joint structure. Compared to the jointing of vertical section, the slope-shaped groove reduces the average melting depth on the aluminum side, and the heat input is more used for interface reactions, increasing the generation amount of intermetallic compounds by about 335%. And it is convenient to regulate the heat input of the laser, suppress the excessive contact between iron and aluminum atoms caused by local and excessive heat input, control the average thickness of layer of intermetallic compound below 10 μm, and reduce the residual stress and crack tendency of the joint. In addition, the slope-shaped half-lap-type groove on the steel side can support the molten pool, improve the stability of the keyhole, and avoid collapse. Due to the reduction of the melting range of the base material and the distance for bubbles to float and escape, favorable conditions are provided for reducing welding defects such as pores in the weld seam. In summary, the synergistic effect of the slope-shaped half-lap-type groove and laser welding-brazing using laser organically integrates the welding structure with metallurgical regulation, greatly improving the microstructure and mechanical properties of aluminum/steel dissimilar metal jointing.

The above is only the preferred embodiments of the present disclosure. It should be pointed out that for ordinary skilled in the art, several improvements and embellishments can be made without departing from the principles of the present disclosure, and these improvements and embellishments should also be considered as the scope of protection of the present disclosure.

What is claimed is:

1. A laser welding-brazing method for dissimilar aluminum and steel metals, comprising following steps:
step (1): processing a jointed side of an aluminum plate and a jointed side of a steel plate to have slope-shaped grooves to obtain an aluminum plate having a slope-shaped groove and a steel plate having a slope-shaped groove; wherein an angle between a bevel of a groove and a bottom edge of the steel plate having slope-shaped groove is less than 90 degrees; and wherein a sum of the angle and an angle between a bevel of a groove and a bottom edge of the aluminum plate having slope-shaped groove is 180 degrees;
step (2): coating a mixed slurry on the groove of the steel plate having slope-shaped groove obtained in step (1) to obtain a steel plate comprising a coating layer; wherein the mixed slurry comprises flux powder and acetone; and
step (3): jointing the aluminum plate having slope-shaped groove obtained in step (1) and the steel plate containing coating layer obtained in step (2) and welding a jointed seam using a laser to obtain a composite plate; wherein when the jointing is performed, the aluminum plate having slope-shaped groove is arranged above the steel plate comprising a coating layer at a jointing position; and wherein, when the welding is performed by using the laser, a laser beam is aimed at one side of the aluminum plate having slope-shaped groove, and an offset distance between a center of a spot of the laser beam and the jointed seam is calculated according to Formula I:
d=0.6˜0.8*(b/tan θ);
wherein in Formula I, d represents the offset distance, b represents a thickness of a steel plate to be welded, and θ represents the angle between the bevel of the groove and the bottom edge of the steel plate having a slope-shaped groove.

2. The laser welding-brazing method for dissimilar aluminum and steel metals according to claim 1, wherein in step (1), the angle between the bevel of the groove and the bottom edge of the steel plate having slope-shaped groove is 20˜70 degrees.

3. The laser welding-brazing method for dissimilar aluminum and steel metals according to claim 1, wherein in step (2), a thickness of the coating layer is 20˜40 μm.

4. The laser welding-brazing method for dissimilar aluminum and steel metals according to claim 3, wherein in step (2), the thickness of the coating layer is 30 μm.

5. The laser welding-brazing method for dissimilar aluminum and steel metals according to claim 1, wherein in step (2), a mass ratio of the flux powder and the acetone in the mixed slurry is 1:(2˜3).

6. The laser welding-brazing method for dissimilar aluminum and steel metals to claim 1, wherein in step (2), a preprocessing process is performed before coating surface of the steel plate having slope-shaped groove.

7. The laser welding-brazing method for dissimilar aluminum and steel metals according to claim 1, wherein in step (3), a power of the laser beam is 1˜4 kW, a welding speed is 0.4˜1.2 m/min, a defocusing amount is +1˜30 mm, and an inclination angle of the laser beam is 5˜20 degrees.
